(19) United States
(12) Patent Application Publication
(10) Pub. No.: US 2009/0081307 A1
(43) Pub. Date: Mar. 26, 2009

(54) Pesticidal composition

(75) Inventor: Naoki Tsuda, Toyonaka-shi (JP)

Correspondence Address: FOLEY AND LARDNER LLP;SUITE 500, 3000 K STREET NW, WASHINGTON, DC, 20007, US

(73) Assignee: Sumitomo Chemical Company, Limited

(21) Appl. No.: 12/230,751

(22) Filed: Sep. 4, 2008

(30) Foreign Application Priority Data
Sep. 5, 2007 (JP) 2007-229979

(51) Int. Cl. A01N 25/28; A01N 43/40

(52) U.S. Cl. 424/497; 514/345

(57) ABSTRACT

Since a pesticidal composition including a microcapsule formed by covering an oil containing a pesticidal active ingredient and an organic solvent with a wall material made of a thermosetting resin; at least one surfactant having a polyoxyethylene group in a molecule, selected from the group [A]: polyoxyethylene sorbitan fatty acid ester, polyoxyethylene fatty acid ester, polyoxyethylene polyoxypropylene glycol, polyoxyethylene aryl ether, polyoxyethylene castor oil, polyoxyethylene alkyl ether, polyoxyethylene alkyl ether phosphate ester, and polyoxyethylene polyoxypropylene alkyl ether; a thickener and water enables elution control without changing design of microcapsule, it may be suitably used as an aqueous suspended pesticidal composition having elution performance suited for an applied situation.

### BACKGROUND OF THE INVENTION

1. Field of the Invention

The present invention relates to a pesticidal composition, and more specifically, to an aqueous suspended pesticidal composition containing a microencapsulated pesticidal active ingredient.

2. Description of the Background Art

Conventionally, researches and developments for microcapsule formulations for controlling efficacy of a pesticidal active ingredient and improving various safety have been made (see, Japanese Patent Laying-Open No. 2005-247696, for example). In these formulations, material quality and wall thickness of a wall material are designed depending on the required performances such as improvement in stability, reduction in phytotoxicity injury, reduction in toxicity and improvement in residual efficacy, and an encapsulated pesticidal active ingredient.

### SUMMARY OF THE INVENTION

It is an object of the present invention to provide an excellent pesticidal composition containing a microcapsule formed by covering an oil containing a pesticidal active ingredient and an organic solvent with a wall made of a thermosetting resin.

As a result of examination for solving the above object, the inventor of the present application found that a pesticidal composition including a microcapsule formed by covering an oil containing a pesticidal active ingredient and an organic solvent with a wall made of a thermosetting resin; at least one surfactant having a polyoxyethylene group in a molecule, selected from the following group [A]: polyoxyethylene sorbitan fatty acid ester, polyoxyethylene fatty acid ester, polyoxyethylene polyoxypropylene glycol, polyoxyethylene aryl ether, polyoxyethylene castor oil, polyoxyethylene alkyl ether, polyoxyethylene alkyl ether phosphate ester, and polyoxyethylene polyoxypropylene alkyl ether; a thickener; and water is an excellent pesticidal composition for controlling elution of the pesticidal active ingredient contained in the microcapsule, and exerting desired efficacy of the pesticidal active ingredient, and accomplished the present invention.

That is, the present invention is as follows.

The present invention provides a pesticidal composition including a microcapsule formed by covering an oil containing a pesticidal active ingredient and an organic solvent with a wall material made of a thermosetting resin; at least one surfactant having a polyoxyethylene group in a molecule, selected from the following group [A]; a thickener; and water.

Group [A]: polyoxyethylene sorbitan fatty acid ester, polyoxyethylene fatty acid ester, polyoxyethylene polyoxypropylene glycol, polyoxyethylene aryl ether, polyoxyethylene castor oil, polyoxyethylene alkyl ether, polyoxyethylene alkyl ether phosphate ester, and polyoxyethylene polyoxypropylene alkyl ether.

In the present invention, the thermosetting resin is preferably a polyurethane resin or a polyurea resin.

The pesticidal active ingredient is preferably an insect growth regulating active ingredient.

A preferred example of the insect growth regulating active ingredient is 4-phenoxyphenyl 2-(2-pyridyloxy)propyl ether.

According to the present invention, it is possible to readily provide a pesticidal composition having elution performance suited for an applied situation because elution can be controlled without the need of changing the design of the microcapsule. The pesticidal composition is an aqueous pesticidal composition wherein microcapsules having a pesticidal active ingredient therein are suspended in the aqueous phase.

### DESCRIPTION OF THE PREFERRED EMBODIMENTS

The pesticidal composition of the present invention includes a microcapsule formed by covering an oil containing a pesticidal active ingredient and an organic solvent with a wall made of a thermosetting resin; at least one surfactant having a polyoxyethylene group in a molecule, selected from the group [A]: polyoxyethylene sorbitan fatty acid ester, polyoxyethylene fatty acid ester, polyoxyethylene polyoxypropylene glycol, polyoxyethylene aryl ether, polyoxyethylene castor oil, polyoxyethylene alkyl ether, polyoxyethylene alkyl ether phosphate ester, and polyoxyethylene polyoxypropylene alkyl ether, a thickener; and water.

As the pesticidal active ingredient used in the present invention, any ingredient capable of forming an oil which becomes a microcapsule by being dissolved in an organic solvent may be used without particular limitation, and generally 1 to 99% by weight, and preferably 2 to 50% by weight of the pesticidal active ingredient is contained in the oil. As the pesticidal active ingredient, compounds which are active ingredients such as an insecticidal active ingredient, a fungicidal active ingredient, a herbicidal active ingredient, a plant growth regulating active ingredient, and insect growth regulating active ingredient can be recited. Preferably, an active ingredient compound which is an insect growth regulating active ingredient is recited, and concrete examples include the following compounds:

isopropyl(2E,4E)-11-methoxy-3,7,11-trimethyl-2,4-dodecadienoate (methoprene),

ethyl (2E,4E)-3,7,11-trimethyldodeca-2,4-dienoate (hydroprene),

4-phenoxyphenyl 2-(2-pyridyloxy)propyl ether (2-[1-methyl-2-(4-phenoxyphenoxy)ethoxy]pyridine; pyriproxyfen),

propionaldehyde oxime O-2-(4-phenoxyphenoxy)ethyl ether,

propionaldehyde oxime O-2-(4-phenoxyphenoxy)propyl ether,

O-ethyl N-[2-(4-phenoxyphenoxy)ethyl]carbamate (fenoxycarb),

1-(4-ethylphenoxy)-6,7-epoxy-3,7-dimethyl-2-octene (R-20458),

prop-2-ynyl (±)-(E,E)-3,7,11-trimethyldodeca-2,4-dienoate (kinoprene),

(E)-Z-(4-ethylphenoxy)-2,6-dimethyl-2,3-epoxy-6-octene (ethoprene),

1-(4-chlorophenyl)-3-(2,6-difluorobenzoyl) urea (diflubenzuron),

2-chloro-N-[[[4-(trifluoromethoxy)-phenyl]amino]carbonyl] benzamide (triflumuron),

N-[[[5-(4-bromophenyl)-6-methyl-2-pyrazinyl]amino]carbonyl]-2,6-dichloro benzamide (EL 494),

1-(3,5-dichloro-2,4-difluorophenyl)-3-(2,6-difluorobenzoyl) urea (teflubenzuron),

1-[3,5-dichloro-4-(3-chloro-5-trifluoromethyl-2-pyridyloxy)phenyl] -3-(2,6-difluorobenzoyl) urea (chlorfluazuron),

N-[[[3,5-dichloro-4-(1,1,2,2-tetrafluoroethoxy)phenyl]amino]carbonyl]-2,6-difluoro benzamide (XRD-473),

1-[4-(2-chloro-α,α,α-trifluoro-o-tolyloxy)-2-fluorophenyl]-3-(2,6-difluorobenzo yl) urea (flufenoxuron),

1-[3,5-dichloro-4-(1,1,2,2-tetrafluoroethoxy)phenyl]-3-(2,6-difluorobenzoyl) urea (hexaflumuron),

(R,S)-1-[2,5-dichloro-4-(1,1,2,3,3,3-hexafluoropropoxy)phenyl]-3-(2,6-difluoro benzoyl) urea (lufenuron),

(R,S)-1-[3-chloro-4-(1,1,2-trifluoro-2-trifluoromethoxyethoxy)phenyl]-3-(2,6-difluorobenzoyl) urea (novaluron),

1-(2,6-difluorobenzoyl)-3-[2-fluoro-4-(1,1,2,2-tetrafluoroethoxy)phenyl] urea,

1-(2,6-difluorobenzoyl)-3-(2-fluoro-4-trifluoromethylphenyl) urea,

2-tert-butylimino-3-isopropyl-5-phenyl-1,3,5-thiadiazinane-4-one (buprofezin),

N-cyclopropyl-1,3,5-triazine-2,4,6-triamine (cyromazine),

N-tert-butyl-N′-(4-ethylbenzoyl)-3,5-dimethylbenzohydrazide (tebufenozide),

2′-tert-butyl-5-methyl-2′-(3,5-xyloyl) chromane-6-carbohydrazide (chromafenozide),

N-tert-butyl-N′-(3-methoxy-o-toloyl)-3,5-xylohydrazide (methoxyfenozide), and

N-tert-butyl-N′-(4-chlorobenzoyl) benzohydrazide (halofenozide).

As the organic solvent in the pesticidal composition of the present invention, usually, a hydrophobic organic solvent is used, and for example, aromatic hydrocarbons, aliphatic hydrocarbons, aromatic carboxylic acid esters, and aliphatic carboxylic acid esters (e.g., dialkyl ester of aliphatic dicarboxylic acid) can be recited.

Examples of the aromatic hydrocarbons include alkylbenzene (e.g., toluene, xylene), alkylnaphthalene and phenylxylyl ethane, and a mixture thereof. As the aromatic hydrocarbons, commercially available solvents may be used, and examples of such commercially available solvents include Hisol SAS-296 (mixture of 1-phenyl-1-xylylethane and 1-phenyl-1-ethylphenylethane, trade name available from Nippon Oil Corporation), CACTUS SOLVENT HP-MN (methylnaphthalene 80%, trade name available from Nikko Petrochemicals Co., Ltd.), CACTUS SOLVENT HP-DMN (dimethylnaphthalene 80%, trade name available from Nikko Petrochemicals Co., Ltd.), CACTUS SOLVENT P-100 (alkylbenzene having 9 to 10 carbons, trade name available from Nikko Petrochemicals Co., Ltd.), CACTUS SOLVENT P-150 (alkylbenzene, trade name available from Nikko Petrochemicals Co., Ltd.), CACTUS SOLVENT P-180 (mixture of methylnaphthalene and dimethylnaphthalene, trade name available from Nikko Petrochemicals Co., Ltd.), CACTUS SOLVENT P-200 (mixture of methylnaphthalene and dimethylnaphthalene, trade name available from Nikko Petrochemicals Co., Ltd.), CACTUS SOLVENT P-220 (mixture of methylnaphthalene and dimethylnaphthalene, trade name available from Nikko Petrochemicals Co., Ltd.), CACTUS SOLVENT PAD-1 (dimethylmonoisopropylnaphthalene, trade name available from Nikko Petrochemicals Co., Ltd.), Solvesso 100 (aromatic hydrocarbon, trade name available from Exxon Chemical Company), Solvesso 150 (aromatic hydrocarbon, trade name available from Exxon Chemical Company), Solvesso 200 (aromatic hydrocarbon, trade name available from Exxon Chemical Company), Swasol 100 (toluene, available from Maruzen Petrochemical Co., Ltd.), and Swasol 200 (xylene, available from Maruzen Petrochemical Co., Ltd.).

As the dialkyl ester of aliphatic dicarboxylic acid, adipic acid dialkyl ester such as adipic acid dibutyl ester, and adipic acid dioctyl ester can be exemplified. As the diester of aliphatic dicarboxylic acid, commercially available solvents may be used, and examples of such commercially available solvents include VINYCIZER 40 (adipic acid diisobutyl ester, trade name available from Kao Corporation), and VINYCIZER 50 (adipic acid diisodecyl ester, trade name available from Kao Corporation).

In the present invention, as the wall material that forms a wall in the microcapsule, for example, a thermosetting resin such as a polyurethane resin, a polyurea resin, a polyamide resin, a polyester resin, a polysulfonate resin, an urea formalin resin, a melamine urea resin, a phenol formalin resin and the like may be used. In the present invention, a wall material capable of forming a wall by interfacial polymerization at the interface between the oil containing a pesticidal active ingredient and an organic solvent and water is preferred, and a wall of a polyurethane resin or a polyurea resin is preferred.

The polyurethane resin or polyurea resin used in the present invention is a resin generating through reaction between a polyisocyanate compound, and a polyalcohol compound or a polyamine compound. Examples of the polyisocyanate compound include hexamethylene diisocyanate, an adduct of hexamethylene diisocyanate and trimethylol propane, a biuret condensate of three molecules of hexamethylene diisocyanate, an adduct of tolylene diisocyanate and trimethylol propane, an isocyanurate condensate of tolylene diisocyanate, an isocyanurate condensate of hexamethylene diisocyanate, an isocyanurate condensate of isophorone diisocyanate, isocyanate prepolymer in which one of isocyanate moieties of hexamethylene diisocyanate forms an isocyanurate structure together with two molecules of tolylene diisocyanate, and the other of isocyanate moieties forms an isocyanurate structure together with another two molecules of hexamethylene diisocyanate, 4,4′-methylenebis(cyclohexyl isocyanate), and trimethylhexamethylene diisocyanate, and among these, an adduct of trimethylolpropane and tolylene diisocyanate, an adduct of trimethylolpropane and hexamethylene diisocyanate, a hexamethylene diisocyanate trimer having biuret bond, and multivalent isocyanate having an isocyanurate structure are preferably used.

As the polyalcohol compound, for example, ethylene glycol, propylene glycol, butylene glycol, and cyclopropylene glycol can be recited, and as the polyamine compound, for example, ethylenediamine, hexamethylenediamine, diethylenetrilamine, and triethylenetetramine can be exemplified.

The microcapsule formed by covering such an oil containing a pesticidal active ingredient and an organic solvent with a wall material of a thermosetting resin may be produced according to the generally known production method, such as methods described in, for example, Japanese Patent Laying-Open No. 8-53306, Japanese Patent Laying-Open No. 2005-247696, and Japanese Patent Laying-Open No. 2007-63181.

Among the surfactants having a polyoxyethylene group in a molecule, used in the pesticidal composition of the present invention, as the polyoxyethylene sorbitan fatty acid ester, for example, polyoxyethylene sorbitan monolaurate, polyoxyethylene sorbitan monopalmitate, polyoxyethylene sorbitan monostearate, polyoxyethylene sorbitan monooleate, polyoxyethylene sorbitan trioleate, polyoxyethylene sorbitan tristearate, polyoxyethylene sorbitan triisostearate and polyoxyethylene sorbitol tetraoleate are recited, and concrete examples include:

Ecoteric series (available from HUNTSUMAN, trade name): Ecoteric T20 (polyoxyethylene sorbitan monolaurate), Ecoteric T60 (polyoxyethylene sorbitan monostearate), Ecoteric T61 (polyoxyethylene sorbitan monostearate), Ecoteric T80 (polyoxyethylene sorbitan monooleate), and Ecoteric T85 (polyoxyethylene sorbitan trioleate);

Leodol series (Kao Corporation, trade name): Leodol TW-L106 (polyoxyethylene sorbitan monolaurate), Leodol TW-L120 (polyoxyethylene sorbitan coconut fatty acid ester), Leodol TW-P120 (polyoxyethylene sorbitan monopalmitate), Leodol TW-S 1 06V (polyoxyethylene sorbitan monostearate), Leodol TW-S 1 20V (polyoxyethylene sorbitan monostearate), Leodol TW-S320V (polyoxyethylene sorbitan tristearate), Leodol TW-0106V (polyoxyethylene sorbitan monooleate), Leodol TW-0120V (polyoxyethylene sorbitan monooleate), Leodol TW-0320V (polyoxyethylene sorbitan trioleate), Leodol TW-IS399C (polyoxyethylene sorbitan triisostearate), and Leodol Super TW-L120 (polyoxyethylene sorbitan coconut fatty acid ester);

IONET series (Sanyo Chemical Industries, Ltd., trade name): IONET T-20C (polyoxyethylene sorbitan coconut fatty acid ester), IONET T-60V (polyoxyethylene sorbitan monostearate), and IONET T-80V (polyoxyethylene sorbitan monooleate);

Pionin series (Takemoto Oil & Fat Co., Ltd., trade name): Pionin D-941 (polyoxyethylene sorbitan monolaurate), Pionin D-944 (polyoxyethylene sorbitan monostearate), Pionin D-945 (polyoxyethylene sorbitan monooleate), Pionin D-945-T (polyoxyethylene sorbitan trioleate);

Solbon series (Toho Chemical Industry Co., Ltd., trade name): Solbon T-20 (polyoxyethylene sorbitan monolaurate), Solbon T-40 (polyoxyethylene sorbitan monopalmitate), Solbon T-60 (polyoxyethylene sorbitan monostearate), Solbon T-80 (polyoxyethylene sorbitan monooleate), Solbon T-85 (polyoxyethylene sorbitan trioleate);

BLAUNON series (Aoki Oil Industrial Co., Ltd., trade name): BLAUNON ST-21 (polyoxyethylene sorbitan monostearate), BLAUNON OT-21 (polyoxyethylene sorbitan monooleate); and

SOLGEN series (Dai-ichi Kogyo Seiyaku Co., Ltd., trade name): SOLGEN TW-20 (polyoxyethylene sorbitan coconut fatty acid ester), SOLGEN TW-60 (polyoxyethylene sorbitan monostearate), SOLGEN TW-80 (polyoxyethylene sorbitan monooleate).

Among the surfactants having a polyoxyethylene group in a molecule, which may be used in the pesticidal composition of the present invention, as the polyoxyethylene fatty acid ester, for example, polyethylene glycol monolaurate, polyethylene glycol monostearate, polyethylene glycol distearate, polyethylene glycol monooleate, polyethylene glycol dioleate, polyoxyethylene dilaurate, polyoxyethylenen laurate, polyoxyethylene stearate, polyoxyethylene distearate, polyoxyethylene dioleate and pollyoxyethylene oleate can be recited, and concrete examples include:

Ecoterlc series (HUNTSUMAN, trade name): Ecoteric M52F USP (polyoxyethylene stearate);

EMANON series (Kao Corporation, trade name): EMANON 1112 (polyethylene glycol monolaurate), EMANON 3199 (polyethylene glycol monostearate), EMANON 3299 (polyethylene glycol distearate), EMANON 3299R (polyethylene glycol distearate), EMANON 4110 (polyethylene glycol monooleate);

IONET series (Sanyo Chemical Industries, Ltd., trade name): IONET MS-400 (polyethylene glycol monostearate), IONET MS-1000 (polyethylene glycol monostearate), IONET MO-200 (polyethylene glycol monooleate), IONET MO-400 (polyethylene glycol monooleate), IONET MO-600 (polyethylene glycol monooleate), IONET DL-200 (polyethylene glycol distearate), IONET DS-300 (polyethylene glycol distearate), IONET DS-400 (polyethylene glycol distearate), IONET DS-4000 (polyethylene glycol distearate), IONET DO-400 (polyethylene glycol dioleate), IONET DO-600 (polyethylene glycol dioleate), IONET DO-1000 (polyethylene glycol dioleate);

EMULMIN series (Sanyo Chemical Industries, Ltd., trade name): EMULMIN 862 (polyethylene glycol distearate);

Pionin series (Takemoto Oil & Fat Co., Ltd., trade name): Pionin D-2104-D (polyoxyethylene dilaurate), Pionin D-2112-A (polyoxyethylene laurate), Pionin D-2112-C (polyoxyethylene laurate), Pionin D-2123-C (polyoxyethylene laurate), Pionin D-2405-A (polyoxyethylene stearate), Pionin D-2410-D (polyoxyethylene distearate), Pionin D-2506-D (polyoxyethylene dioleate), Pionin D-2507-A (polyoxyethylene oleate);

NOIGEN series (Dai-ichi Kogyo Seiyaku Co., Ltd., trade name): NOIGEN ES-99D (polyoxyethylene oleate), NOIGEN ES-99 (polyoxyethylene oleate), NOIGEN ES-129D (polyoxyethylene oleate), NOIGEN ES-129 (polyoxyethylene oleate), NOIGEN ES-149 (polyoxyethylene oleate), NOIGEN ES-149D (polyoxyethylene oleate), NOIGEN ES-169 (polyoxyethylene oleate), NOIGEN DS-601 (polyoxyethylene distearate); and

LAMIGEN series (Dai-ichi Kogyo Seiyaku Co., Ltd., trade name): LAMIGEN ES-30 (polyoxyethylene lanolate), LAMIGEN ES-60 (polyoxyethylene lanolate), LAMIGEN ES-100 (polyoxyethylene lanolate).

Among the elution controlling substances having a polyoxyethylene group in a molecule, which may be used in the pesticidal composition of the present invention, concrete examples of the polyoxyethylene polyoxypropylene glycol include:

SURFONIC series (HUNTSUMAN, trade name): SURFONIC POA-L61, SURFONIC POA-L62, SURFONIC POA-L62LF, SURFONIC POA-L100, SURFONIC POA-P84, SURFONIC POA-17R2, SURFONIC POA-25R2, SURFONIC POA-P104, SURFONIC POA-25R2, SURFONIC POA-104, SURFONIC POA-PIO5 (these are polyoxyethylene polyoxypropylene glycol);

EMULGEN series (Kao Corporation, trade name): EMULGEN PP-290 (polyoxyethylene polyoxypropylene glycol);

Newpole series (Sanyo Chemical Industries, Ltd., trade name): Newpole PE-61, Newpole PE-62, Newpole PE-64, Newpole PE-68, Newpole PE-71, Newpole PE-74, Newpole PE-75, Newpole PE-78, Newpole PE-108 (these are polyoxyethylene polyoxypropylene glycol);

Pionin series (Takemoto Oil & Fat Co., Ltd., trade name): Pionin P-1525, Pionin P-2310, Pionin P-2535, Pionin P-3750, Pionin P-4015, Pionin P-2280 (these are polyoxyethylene polyoxypropylene glycol);

Pepole series (Toho Chemical Industry Co., Ltd., trade name): Pepole B-181, Pepole B-182, Pepole B-184, Pepole B-188 (these are polyoxyethylene polyoxypropylene glycol);

BLAUNON series (Aoki Oil Industrial Co., Ltd., trade name): BLAUNON P-101M, BLAUNON P-106, BLAUNON P-171, BLAUNON P-172, BLAUNON P-174, BLAUNON P-P210, BLAUNON P-301, BLAUNON P-304, BLAUNON EP-0840, BLAUNON EP-0480, BLAUNON EP-0670, BLAUNON EP-1461 (these are polyoxyethylene polyoxypropylene glycol); and

Epan series (Dai-ichi Kogyo Seiyaku Co., Ltd., trade name): Epan 410, Epan 420, Epan 450, Epan 485, Epan 610, Epan 640, Epan 680, Epan 710, Epan 720, Epan 740, Epan 750, Epan 785, Epan U-103, Epan U-105, Epan U-108 (these are polyoxyethylene polyoxypropylene glycol).

Among the surfactants having a polyoxyethylene group in a molecule, which may be used in the pesticidal composition of the present invention, as the polyoxyethylene aryl ether, for example, polyoxyethylene octylphenyl ether, polyoxyethylene nonylphenyl ether, polyoxyethylene dodecylphenyl ether, polyoxyethylene styrenated phenyl ether, polyoxyethylenephenyl ether, polyoxyethylene benzyl ether, polyoxyethylene β-naphthyl ether, polyoxyethylene bisphenol A ether and polyoxyethylene bisphenol F ether can be recited, and concrete examples include:

SURFONIC series (HUNTSUMAN, trade name): SURFONIC N-40, SURFONIC N-60, SURFONIC N-85, SURFONIC N-95, SURFONIC N-100, SURFONIC N-120, SURFONIC N-300, SURFONIC N-400, SURFONIC N-550 (these are polyoxyethylene nonylphenyl ether);

EMULGEN series (Kao Corporation, trade name): EMULGEN A-60, EMULGEN A-90, EMULGEN A-500 (these are polyoxyethylene styrenated phenyl ether);

BLAUNON series (Aoki Oil Industrial Co., Ltd., trade name): BLAUNON N-502, BLAUNON N-503, BLAUNON N-504, BLAUNON N-505, BLAUNON N-506, BLAUNON N-507, BLAUNON N-508, BLAUNON N-5058, BLAUNON N-509, BLAUNON N-5095, BLAUNON N-510, BLAUNON N-511, BLAUNONN-512, BLAUNON N-513, BLAUNON N-514, BLAUNON N-515, BLAUNONN-516, BLAUNON N-520, BLAUNON N-525, BLAUNON N-530, BLAUNONN-550 (these are polyoxyethylene nonylphenyl ether);

BLAUNON NK-8055, BLAUNON NK-808, BLAUNON NK-810, BLAUNON NK-815, BLAUNON NK-824, BLAUNON NK-830 (these are polyoxyethylene octylphenyl ether); BLAUNON DP-9, BLAUNON DP-20, BLAUNON DSP-9, BLAUNON DSP-12.5, BLAUNON TSP-7.5, BLAUNON TSP-16, BLAUNON TSP-50 (these are polyoxyethylene styrenated phenyl ether);

BLAUNON PH-5 (polyoxyethylenephenyl ether);

BLAUNON BA-1, BLAUNON BA-2 (these are polyoxyethylene benzyl ether);

BLAUNON BN-3, BLAUNON BN-10, BLAUNON BN-25 (these are polyoxyethylene β-naphthyl ether);

BLAUNON BEO-4, BLAUNON BEO-6, BLAUNON BEO-10, BLAUNON BEO-17.5, BLAUNON BEO20, BLAUNON BEO30 (these are polyoxyethylene bisphenol A ether);

BLAUNON BFE-10 (polyoxyethylene bisphenol F ether); and

NOIGEN series (Dai-ichi Kogyo Seiyaku Co., Ltd., trade name): NOIGEN EA-87, NOIGEN EA-137, NOIGEN EA-157, NOIGEN EA-167, NOIGEN EA-177, NOIGEN EA-197, NOIGEN EA-207 (these are polyoxyethylene styrenated phenyl ether).

Among the surfactants having a polyoxyethylene group in a molecule, which may be used in the pesticidal composition of the present invention, as the polyoxyethylene castor oil, for example, those having a polyoxyethylene chain of an added mol number of ethylene oxide (hereinafter, denoted by “EO added mol number”) of about 2 to 200 can be recited, and concrete examples include:

Sorpol series (Toho Chemical Industry Co., Ltd., trade name): Sorpol CA30, Sorpol CA42;

BLAUNON series (Aoki Oil Industrial Co., Ltd., trade name): BLAUNON BR-404 (EO added mol number 4), BLAUNON BR-406 (EO added mol number 6), BLAUNON BR-407 (EO added mol number 7), BLAUNON BR-410 (EO added mol number 10), BLAUNON BR-4135 (EO added mol number 13.5), BLAUNON BR-417 (EO added mol number 17), BLAUNON BR-420 (EO added mol number 20), BLAUNON BR-425 (EO added mol number 25), BLAUNON BR-430 (EO added mol number 30), BLAUNON BR-450 (EO added mol number 50);

Pionin series (Takemoto Oil & Fat Co., Ltd., trade name): Pionin D-206, Pionin D-212, Pionin D-225, D-240-W;

NOIGEN series (Dai-ichi Kogyo Seiyaku Co., Ltd., trade name): NOIGEN CX-40, NOIGEN CX-100;

Alkamuls series (Rhodia Nicca, trade name): Alkamuls R81, Alkamuls BR, Alkamuls OR/40, Alkamuls 14R; and

TERMUL series (HUNTSUMAN, trade name): TERMUL 1283, TERMUL 1284, TERMUL 1285, TERMUL 2507, TERMUL 3512, TERMUL 3540.

Among the surfactants having a polyoxyethylene group in a molecule, which may be used in the pesticidal composition of the present invention, as the polyoxyethylene alkyl ether, for example, polyoxyethylene decyl ether, polyoxyethylene lauryl ether, polyoxyethylene coconut alcohol ether, polyoxyethylene essential oil coconut alcohol ether, polyoxyethylene cetyl ether, polyoxyethylene stearyl ether, polyoxyethylene oleyl ether, polyoxyethylene 2-ethylhexyl ether, polyoxyethylene isodecyl ether, polyoxyethylene synthetic alcohol ether, polyoxyethylene secondary alcohol ether, polyoxyethylene tridecyl ether, polyoxyethylene isostearyl alcohol and polyoxyethylene long-chain alkyl ether can be recited, and concrete examples include:

EMULGEN series (Kao Corporation, trade name): EMULGEN 104P, EMULGEN 106, EMULGEN 123P (these are polyoxyethylene lauryl ether);

EMULGEN 210P, EMULGEN 220 (these are polyoxyethylene cetyl ether);

EMULGEN 306P, EMULGEN 320P (these are polyoxyethylene stearyl alcohol);

EMULGEN 420 (polyoxyethylene oleyl ether);

EMULGEN 2020G-HA, EMULGEN 2025G (these are polyoxyethylene octyldodecyl ether);

BLAUNON series (Aoki Oil Industrial Co., Ltd., trade name): BLAUNON EL-1303, BLAUNON EL-1305, BLAUNONE EL-1307, BLAUNON EL-1310 (these are polyoxyethylene decyl ether);

BLAUNON EL-1502.2, BLAUNON EL-1503P, BLAUNON EL-1505P, BLAUNON EL-1508P, BLAUNDN EL-1512P, BLAUNON EL-1515, BLAUNON EL-1519P, BLAUNON EL-1521, BLAUNON EL-1530, BLAUNON EL-1540P (these are polyoxyethylene lauryl ether);

BLAUNON CH-302, BLAUNON CH-305, BLAUNON CH-308, BLAUNON CH-310, BLAUNON CH-313, BLAUNON CH-315, BLAUNON CH-320, BLAUNON CH-340 (these are polyoxyethylene cetyl ether);

BLAUNON SR-7033, BLAUNON SR-705, BLAUNON SR-707, BLAUNON SR-710, BLAUNON SR-711, BLAUNON SR-715, BLAUNON SR-720, BLAUNON SR-730, BLAUNON SR-750, BLAUNON SR-825 (these are polyoxyethylene stearyl ether);

BLAUNON EN-1502, BLAUNON EN-1504, BLAUNON EN-1506, BLAUNON EN-1507, BLAUNON EN-1509, BLAUNON EN-1510, BLAUNON EN-1511, BLAUNON EN-1520, BLAUNON EN-1530, BLAUNON EN-1540, BLAUNON EN-1560, BLAUNON EN-614A, BLAUNON EN-620, BLAUNON EN-905, BLAUNON EN-909, BLAUNON EN-914, BLAUNON EN-920 (these are polyoxyethylene oleyl ether);

BLAUNON EH-2, BLAUNON EH-4, BLAUNON EH-6, BLAUNON EH-11, BLAUNON EH-30 (these are polyoxyethylene 2-ethylhexyl ether); BLAUNON DAL-2, BLAUNON DAL-5, BLAUNON DAL-10, BLAUNON DAH-3, BLAUNON DAH-7, BLAUNON OX-33, BLAUNON OX-58, BLAUNON OX-70, BLAUNON OX-92 (these are polyoxyethylene synthetic alcohol ether);

BLAUNON UNA-450, BLAUNON UNA-480 (these are polyoxyethylene long-chain alkyl ether);

COCOSURF series (Aoki Oil Industrial Co., Ltd., trade name): COCOSURF 70, COCOSURF 120 (these are polyoxyethylene coconut alcohol ehter), COCOSURF HG-50, COCOSURF HG-75, COCOSURF HG-95 (these are polyoxyethylene essential oil coconut alcohol ether);

FINESURF series (Aoki Oil Industrial Co., Ltd., trade name): FINESURF D-35, FINESURF D-55, FINESURF D-60, FINESURF D-65, FINESURF D-85 (these are polyoxyethylene isodecyl ether);

FINESURF 230, FINESURF 250, FINESURF 270, FINESURF 290, FINESURF 320, FINESURF 350, FINESURF 400, FINESURF 500 (these are polyoxyethylene secondary alcohol ether);

FINESURF TD-30, FINESURF TD-50, FINESURF TD-65, FINESURF TD-70, FINESURF TD-75, FINESURF TD-80, FINESURF TD-90, FINESURF TD-100, FINESURF TD-120, FINESURF TD-150, FINESURF TD-200 (these are polyoxyethylene tridecyl ether);

FINESURF FO-40, FINESURF FO-80, FINESURF FO-120, FINESURF FO-160 (these are polyoxyethylene isostearyl ether); and

SAFETYCUT series (Aoki Oil Industrial Co., Ltd., trade name): SAFETYCUT ID-1033, SAFETYCUT ID-1055, SAFETYCUT ID-1061 (these are polyoxyethylene isodecyl ether).

Among the surfactants having a polyoxyethylene group in a molecule, which may be used in the pesticidal composition of the present invention, as the polyoxyethylene alkyl ether phosphate ester, for example, polyoxyethylene lauryl ether phosphate, polyoxyethylene stearyl ether phosphate, polyoxyethylene oleyl ether phosphate and polyoxyethylene alkylphenyl ether phosphate can be recited, and concrete examples include:

PHOSPHANOL series (Toho Chemical Industry Co., Ltd., trade name): PHOSPHANOL ML-220, PHOSPHANOL RD-510Y (these are polyoxyethylene lauryl ether phosphate);

PHOSPHANOL RS-410, PHOSPHANOL RS-610, PHOSPHANOL RS-710 (these are polyoxyethylene alkyl ether phosphate);

PHOSPHANOL RL-210, PHOSPHANOL RL-310 (these are polyoxyethylene stearyl ether phosphate);

PHOSPHANOL RB-410 (polyoxyethylene oleyl ether phosphate), PHOSPHANOL RE-410, PHOSPHANOL PE-510, PHOSPHANOL RE-610 (these are polyoxyethylene alkylphenyl ether phosphate);

PRISURF series (Dai-ichi Kogyo Seiyaku Co., Ltd., trade name): PRISURF AL (polyoxyethylene alkylphenyl ether phosphate);

PRISURF A212C, PRISURF A215C (these are polyoxyethylene tridecyl ether phosphate);

PRISURF A208B (polyoxyethylene lauryl ether phosphate);

PRISURF A219B (polyoxyethylene lauryl ether phosphate);

PRISURF A208S (polyoxyethylene synthetic alcohol ether phosphate);

PRISURF A208F (polyoxyethylene octyl ether phosphate); and

PRISURF M208F (polyoxyethylene octyl ether phosphate salt).

Among the surfactants having a polyoxyethylene group in a molecule, which may be used in the pesticidal composition of the present invention, as the polyoxyethylene polyoxypropylene alkyl ether, for example, polyoxyethylene polyoxypropylene decyl ether, polyethylene polyoxypropylene lauryl ether, polyoxyethylene polyoxypropylene (2-ethylhexyl) ether, polyoxyethylene polyoxypropylene isodecyl ether, polyoxyethylene polyoxypropylene synthetic alcohol ether and polyoxyethylene polyoxypropylene tridecyl ether, and concrete examples include:

Pepole series (Toho Chemical Industry Co., Ltd., trade name): Pepole BEP-0115 (polyoxyethylene polyoxypropylene behenyl ether);

FINESURF series (Aoki Oil Industrial Co., Ltd., trade name): FINESURF NDB-800, FINESURF NDB-1000, FINESURF NDB-1400 (these are polyethylene polyoxypropylene decyl ether);

WONDERSURF series (Aoki Oil Industrial Co., Ltd., trade name): WONDERSURF 80, WONDERSURF 100, WONDERSURF 140 (these are polyethylene polyoxypropylene lauryl ether); and

WONDERSURF S-800, WONDERSURF S-1000, WONDERSURF S-1400, (these are polyethylene polyoxypropylene tridecyl ether).

In the pesticidal composition of the present invention, the content of the surfactant having a polyoxyethylene group in a molecule is generally about 0.01 to 1% by weight.

In the pesticidal composition of the present invention, the oil is contained in a proportion of typically about 0.0003 to 0.09% by weight. Further, the contents of the pesticidal active ingredient and the organic solvent are typically about 0.0001 to 0.03% by weight and 0.0002 to 0.06% by weight, respectively, in the pesticidal composition of the present invention.

The amount of the wall substance is typically about 0.0009 to 0.01% by weight in the pesticidal composition of the present invention.

As the thickener used in the pesticidal composition of the present invention, for example, natural polysaccharides such as xanthan gum, rhamsan gum, locust bean gum, carrageenan and welan gum, synthetic polymers such as sodium polyacrylate, semi-synthetic polysaccharides such as carboxymethyl cellulose, micropowder of mineral substances such as aluminum magnesium silicate, smectite, bentonite, hectorite and dry-method silica, alumina sol and the like can be exemplified. In the pesticidal composition of the present invention, such a thickener is contained in a proportion of typically about 0.0009 to 0.0002% by weight.

The pesticidal composition of the present invention may be produced by mixing a microcapsule formed by covering an oil containing a pesticidal active ingredient and an organic solvent with a wall material made of a thermosetting resin, or a slurry containing the microcapsule, with a thickener, a surfactant having a polyoxyethylene group in a molecule, and water.

The amount of the water is typically about 99.9 to 99.998% by weight in the pesticidal composition of the present invention.

The pesticidal composition of the present invention may further include other ingredient such as formulation anxiliaries as far as the effect of the present invention is not damaged.

In the pesticidal composition of the present invention, the microcapsules are generally suspended in the aqueous phase; and thus, the pesticidal composition forms an aqueous suspended composition.

The pesticidal composition of the present invention may be used in a normal pesticidal spraying situation, directly or after being diluted with water or the like of about 1 to 10000 times by weight per 1 part by weight of the pesticidal composition of the present invention.

As such a spraying method, for example, a method of spraying by using a plant sprayer to the plant body, soil and the like to be protected by the pesticidal active ingredient can be recited. The plant sprayer sprays the pesticidal composition or a diluted solution thereof in mist form under pressurizing, and those used in knapsack style, portable style, stationary style and running style, as well as that used by an unmanned helicopter are known. The pesticidal composition of the present invention is particularly suited for spraying to a plant body (leaf, stem and so on) and a solid phase surface such as soil or the like.

In the following, the present invention will be described more specifically by way of examples and test examples, however, the present invention will not be limited to these examples.

### EXAMPLE 1

90 g of pyriproxyfen, 100 g of Hisol SAS-296 (mixture of 1-phenyl-1-xylylethane and 1-phenyl-1-ethylphenyl ethane, available from Nippon Oil Corporation) and 50 g of VINYCIZER 40 (adipic acid diisobutyl ester, available from Kao Corporation) were mixed, and 2.4 g of SUMIJULE N-3300 (isocyanurate-type polyvalent isocyanate, available from Sumika Bayer Urethane Co., Ltd.) was added thereto, to prepare an oil phase.

On the other hand, 17.5 g of gum arabic, 40 g of ethylene glycol and 344.4 g of ion exchange water were mixed to prepare an aqueous layer.

The oil layer and the aqueous layer were mixed, and the resultant mixture was subjected to dispersion at 25° C. with the use of a T.K. autohomomixer (homogenizer available from Tokusyu Kikakogyo) for 5 minutes at about 6100 rpm. Then, the dispersion was stirred gently at 75° C. for 48 hours, to obtain a microcapsule slurry.

Then, a thickener solution prepared by mixing 1.5 g of xanthan gum, 3 g of aluminum magnesium silicate, 50 g of propylene glycol and 295.1 g of ion exchange water was mixed with the above microcapsule slurry, to obtain an aqueous suspension containing 9.0% by weight of pyriproxyfen.

1 g of the aqueous suspension was diluted with 999 g of ion exchange water, to prepare a diluted solution (hereinafter, referred to as the diluted solution (A)). To the diluted solution (A), 1 g of Pionin D-941 (polyoxyethylene sorbitan monolaurate, available from Takemoto Oil & Fat Co., Ltd.) was added as a surfactant having a polyoxyethylene group in a molecule, to obtain a pesticidal composition of the present invention (hereinafter, referred to as Pesticidal composition (1)).

### EXAMPLE 2

To the diluted solution (A), 1 g of Pionin D-944 (polyoxyethylene sorbitan monostearate, available from Takemoto Oil & Fat Co., Ltd.) was added as a surfactant having a polyoxyethylene group in a molecule, to obtain a pesticidal composition of the present invention (hereinafter, referred to as Pesticidal composition (2)).

### EXAMPLE 3

To the diluted solution (A), 1 g of Pionin D-945-T (polyoxyethylene sorbitan trioleate, available from Takemoto Oil & Fat Co., Ltd.) was added as a surfactant having a polyoxyethylene group in a molecule, to obtain a pesticidal composition of the present invention (hereinafter, referred to as Pesticidal composition (3)).

### EXAMPLE 4

To the diluted solution (A), 1 g of Pionin D-2405-A (polyoxyethylene stearate, available from Takemoto Oil & Fat Co., Ltd.) was added as a surfactant having a polyoxyethylene group in a molecule, to obtain a pesticidal composition of the present invention (hereinafter, referred to as Pesticidal composition (4)).

### EXAMPLE 5

To the diluted solution (A), 1 g of Pionin D-2410-D (polyoxyethylene distearate, available from Takemoto Oil & Fat Co., Ltd.) was added as a surfactant having a polyoxyethylene group in a molecule, to obtain a pesticidal composition of the present invention (hereinafter, referred to as Pesticidal composition (5)).

### EXAMPLE 6

To the diluted solution (A), 1 g of Pionin D-2507-A (polyoxyethylene oleate, available from Takemoto Oil & Fat Co., Ltd.) was added as a surfactant having a polyoxyethylene group in a molecule, to obtain a pesticidal composition of the present invention (hereinafter, referred to as Pesticidal composition (6)).

### EXAMPLE 7

To the diluted solution (A), 1 g of FINESURF NDB-1400 (polyoxyethylene polyoxypropylene decyl ether, available from Aoki Oil Industrial Co., Ltd.) was added as a surfactant having a polyoxyethylene group in a molecule, to obtain a pesticidal composition of the present invention (hereinafter, referred to as Pesticidal composition (7)).

### EXAMPLE 8

To the diluted solution (A), 1 g of FINESURF TD- 100 (polyoxyethylene tridecyl ether, available from Aoki Oil Industrial Co., Ltd.) was added as a surfactant having a polyoxyethylene group in a molecule, to obtain a pesticidal composition of the present invention (hereinafter, referred to as Pesticidal composition (8)).

### EXAMPLE 9

To the diluted solution (A), 1 g of BLAUNON P-106 (polyoxyethylene polyoxypropylene glycol ((EO/PO)=(60/40)) available from Aoki Oil Industrial Co., Ltd.) was added as the surfactant having a polyoxyethylene group in a molecule, to obtain a pesticidal composition of the present invention (hereinafter, referred to as Pesticidal composition (9)).

### EXAMPLE 10

To the diluted solution (A), 1 g of BLAUNON P-304 (polyoxyethylene polyoxypropylene glycol ((EO/PO)=(40/60)) available from Aoki Oil Industrial Co., Ltd.) was added as the surfactant having a polyoxyethylene group in a molecule, to obtain a pesticidal composition of the present invention (hereinafter, referred to as Pesticidal composition (10)).

### EXAMPLE 11

To the diluted solution (A), 1 g of BLAUNON TSP-7.5 (polyoxyethylene styrenated phenyl ether, available from Aoki Oil Industrial Co., Ltd.) was added as the surfactant having a polyoxyethylene group in a molecule, to obtain a pesticidal composition of the present invention (hereinafter, referred to as Pesticidal composition (11)).

### EXAMPLE 12

To the diluted solution (A), 1 g of BLAUNON TSP-16 (polyoxyethylene styrenated phenyl ether, available from Aoki Oil Industrial Co., Ltd.) was added as the surfactant having a polyoxyethylene group in a molecule, to obtain a pesticidal composition of the present invention (hereinafter, referred to as Pesticidal composition (12)).

### EXAMPLE 13

To the diluted solution (A), 1 g of BLAUNON BR-417 (polyoxyethylene castor oil, available from Aoki Oil Industrial Co., Ltd.) was added as the surfactant having a polyoxyethylene group in a molecule, to obtain a pesticidal composition of the present invention (hereinafter, referred to as Pesticidal composition (13)).

### EXAMPLE 14

To the diluted solution (A), 1 g of BLAUNON CH-310 (polyoxyethylene cetyl ether ((EO)=10)), available from Aoki Oil Industrial Co., Ltd.) was added as the surfactant having a polyoxyethylene group in a molecule, to obtain a pesticidal composition of the present invention (hereinafter, referred to as Pesticidal composition (14)).

### EXAMPLE 15

To the diluted solution (A), 1 g of BLAUNON CH-315 (polyoxyethylene cetyl ether ((EO) =15)), available from Aoki Oil Industrial Co., Ltd.) was added as the surfactant having a polyoxyethylene group in a moleule, to obtain a pesticidal composition of the present invention (hereinafter, referred to as Pesticidal composition (15)).

### EXAMPLE 16

To the diluted solution (A), 1 g of BLAUNON SR-711 (polyoxyethylene stearyl ether ((EO)=11)), available from Aoki Oil Industrial Co., Ltd.) was added as the surfactant having a polyoxyethylene group in a molecule, to obtain a pesticidal composition of the present invention (hereinafter, referred to as Pesticidal composition (16)).

### EXAMPLE 17

To the diluted solution (A), 1 g of BLAUNON SR-715 (polyoxyethylene stearyl ether ((EO)=15)), available from Aoki Oil Industrial Co., Ltd.) was added as the surfactant having a polyoxyethylene group in a molecule, to obtain a pesticidal composition of the present invention (hereinafter, referred to as Pesticidal composition (17)).

### EXAMPLE 18

To the diluted solution (A), 1 g of PHOSPHANOL RS-610 (polyoxyethylene alkyl ether phosphoric acid available from Toho Chemical Industry Co., Ltd.) was added as the surfactant having a polyoxyethylene group in a molecule, to obtain a pesticidal composition of the present invention (hereinafter, referred to as Pesticidal composition (18)).

### COMPARATIVE EXAMPLE

To the diluted solution (A), 1 g of sodium dodecyl sulfate was added, to obtain a pesticidal composition (hereinafter, referred to as Comparative composition (B)).

### TEST EXAMPLE

Each 5 mL of Pesticidal compositions (1) to (18), Comparative composition (B) and the diluted solution (A) was placed on a Petri Dish, dried until the moisture is no longer present, and then pyriproxyfen was extracted by decane and an elution amount of pyriproxyfen that was present outside the microcapsule was measured by gas chromatography (internal standard method). An elution control index was determined by comparison with an elution amount in the test for the diluted solution (A) according to the following formula. The result is shown in Table 1.

TABLE 1

| | Elution control |
|---|---|
| Tested composition | index |
| Pesticidal composition (1) | 4.1 |
| Pesticidal composition (2) | 4.6 |
| Pesticidal composition (3) | 4.8 |
| Pesticidal composition (4) | 3.7 |
| Pesticidal composition (5) | 3.3 |
| Pesticidal composition (6) | 7.3 |
| Pesticidal composition (7) | 4.2 |
| Pesticidal composition (8) | 3.6 |
| Pesticidal composition (9) | 3.8 |
| Pesticidal composition (10) | 5.7 |
| Pesticidal composition (11) | 3.2 |
| Pesticidal composition (12) | 3.2 |
| Pesticidal composition (13) | 4.6 |
| Pesticidal composition (14) | 2.8 |
| Pesticidal composition (15) | 3.2 |
| Pesticidal composition (16) | 2.1 |
| Pesticidal composition (17) | 3.0 |
| Pesticidal composition (18) | 8.1 |
| Comparative composition (B) | 1.0 |
| Diluted solution (A) | 1.0 |

Elution control index = (Elution amount in tested composition)/(Elution amount in diluted solution (A))

1. A pesticidal composition including a microcapsule formed by covering an oil containing a pesticidal active ingredient and an organic solvent with a wall made of a thermosetting resin; at least one surfactant having a polyoxyethylene group in a molecule, selected from the following group [A]; a thickener; and water.
Group [A]: polyoxyethylene sorbitan fatty acid ester, polyoxyethylene fatty acid ester, polyoxyethylene polyoxypropylene glycol, polyoxyethylene aryl ether, polyoxyethylene castor oil, polyoxyethylene alkyl ether, polyoxyethylene alkyl ether phosphate ester, and polyoxyethylene polyoxypropylene alkyl ether.

2. The pesticidal composition according to claim 1, wherein said thermosetting resin is a polyurethane resin or a polyurea resin.

3. The pesticidal composition according to claim 1, wherein said pesticidal active ingredient is an insect growth regulating active ingredient.

4. The pesticidal composition according to claim 3, wherein said insect growth regulating active ingredient is 4-phenoxyphenyl 2-(2-pyridyloxy) propyl ether.

5. The pesticidal composition according to claim 1, wherein the contents of the pesticidal active ingredient, the organic solvent, the surfactant, the thickener and the water are 0.0001 to 0.03%, 0.0002 to 0.06%, 0.01 to 1%, 0.0009 to 0.0002% and 99.9 to 99.998% by weight, respectively.
